(19) United States
(12) Patent Application Publication
(10) Pub. No.: US 2013/0270143 A1
(43) Pub. Date: Oct. 17, 2013

(54) TWO-PIECE PACKAGE AND METHOD OF ASSEMBLING THE SAME

(71) Applicants: Zachary Muscato, St. Charles, MO (US); Jeffrey Best, O'Fallon, MO (US); Michael Duff, Orefield, PA (US)

(72) Inventors: Zachary Muscato, St. Charles, MO (US); Jeffrey Best, O'Fallon, MO (US); Michael Duff, Orefield, PA (US)

(21) Appl. No.: 13/446,368

(22) Filed: Apr. 13, 2012

(51) Int. Cl. B65D 51/00; B65D 85/00; B31B 17/00

(52) U.S. Cl. 206/459.5; 493/84; 220/212

(57) ABSTRACT

A two-piece package includes a container and a lid. The container includes a side wall, a bottom, an open end, an open end and a circumferential flange extending outward from the open end. The bottom, the sidewall, and the circumferential flange include a material having oxygen barrier properties. The lid includes a center portion and a rim portion including a body extending substantially perpendicular with respect to the center portion. The lid also includes a film attached to each of the center portion and the rim portion. The film is configured to seal to the circumferential flange. The film also includes a plurality of layers and at least one of the plurality of layers includes a material having oxygen barrier properties.

### BACKGROUND OF THE INVENTION

The field of the invention relates generally to storage containers and, more specifically, to a two-piece package having oxygen barrier properties.

Permeation is a principle in physics and engineering relating to the diffusion of a gas through a solid article. A pressure differential between opposing sides of the article causes gas to pass through pores within an article material. However, some materials are resistant to gas permeability. For example, some materials have oxygen barrier properties such as a low oxygen transmission rate. Oxygen transmission rate is the measurement of the amount of oxygen that passes through a material over a given period. Materials that have oxygen barrier properties are known to be used in the packaging and preservation of stored products.

At least some known packages generally include a container configured to receive products and a lid attached to the container. Moreover, some known packages are formed by a process called in-mold labeling. In-mold labeling is a cost-effective way of integrating decoration into a plastic component during blow molding, injection molding, or thermoforming processes. The in-mold labeling process includes placing a label within a cavity of a mold and placing a plastic blank within the cavity over the label. The label and the blank are then heated and the label adheres to the blank. Another known process that is used in the packaging and preservation of stored products is retort sterilization. Retort sterilization includes placing a product, such as a perishable food, within a container and sealing the container. The container is placed in an autoclave where it is subjected to increased temperature so the contents of the package are sterilized and shelf life is improved.

However, in-mold labeled products generally suffer from deformation due to the high temperatures of retort sterilization. Furthermore, lids formed by the in-mold labeling process may have inadequate sealing properties. Inadequate sealing may result in the ingress of oxygen into the package thereby leading to spoliation of the package contents.

### BRIEF DESCRIPTION OF THE INVENTION

In one embodiment, a method of assembling a two-piece package is provided. The method includes forming a container and forming a lid. The container includes a side wall, a bottom, an open end, and a circumferential flange extending outward from the open end. The bottom, the side wall, and the circumferential flange include a material having oxygen barrier properties. The lid includes a center portion and a rim portion including a body extending substantially perpendicular with respect to the center portion. The lid also includes a film attached to each of the center portion and the rim portion. The film includes a plurality of layers. At least one of the plurality of layers includes a material having oxygen barrier properties. The method also includes attaching the lid to the container such that the film is attached to the circumferential flange to seal the two-piece package.

In another embodiment, a two-piece package is provided. The two-piece package includes a container and a lid. The container includes a side wall, a bottom, an open end, and a circumferential flange extending outward from the open end. The bottom, the side wall, and the circumferential flange include a material having oxygen barrier properties. The lid includes a center portion and a rim portion including a body extending substantially perpendicular with respect to the center portion. The lid also includes a film attached to each of the center portion and the rim portion. The film is configured to seal to the circumferential flange. The film also includes a plurality of layers and at least one of the plurality of layers includes a material having oxygen barrier properties.

In another embodiment, an in-mold labeled lid for use with a container is provided. The lid includes a center portion and a rim portion including a body extending substantially perpendicular with respect to the center portion. The lid also includes a film attached to each of the center portion and the rim portion. The film also includes a plurality of layers and at least one of the plurality of layers includes a material having oxygen barrier properties.

### BRIEF DESCRIPTION OF THE DRAWINGS

FIG. 1 is a perspective view of an exemplary two-piece package.

FIG. 2 is a cross-sectional view of the two-piece package shown in FIG. 1.

FIG. 3 is a perspective view of an exemplary container of the two-piece package shown in FIG. 1.

FIG. 4 is a blown-up cross-sectional view of the container shown in FIG. 3.

FIG. 5 is a cross-sectional view of the lid shown in FIG. 1.

FIG. 6 is a blown-up cross-sectional view of the film of the lid shown in FIG. 5.

### DETAILED DESCRIPTION OF THE INVENTION

The method and apparatus described herein are directed to a two-piece package having oxygen barrier properties that may be used for food storage purposes. The package includes a container and a lid, wherein the lid is formed with an in-mold label. Moreover, the container and the lid are formed from a material having oxygen barrier properties. As a result, the in-mold labeled lid reduces the ingress of oxygen into the package improving the shelf life of package contents.

In regards to the container of the two-piece package, the container may have any suitable configuration to receive perishable products such as a cylindrical or rectangular body shape. In the exemplary embodiments, the lid is formed to substantially conform to the shape of the container to facilitate sealing of the two-piece package. The lid is also configured to seal to the container via a film integrated with the lid. In the exemplary embodiments, the film attaches to the container such that an open end of the container is substantially sealed by the lid. Sealing the open end with the lid facilitates preventing oxygen from reaching the perishable products within the two-piece package.

Furthermore, each of the container and the lid may be formed from a material having oxygen barrier properties to prevent the ingress of oxygen into the two-piece package. For example, the container may be formed with a plurality of layers by any suitable process. In the exemplary embodiment, at least one of the layers is constructed of a material that has oxygen barrier properties. Similarly, the lid may be formed with a plurality of layers, wherein at least one of the layers is constructed of a material that has oxygen barrier properties. Moreover, in the exemplary embodiments, the plurality of layers of both the container and the lid are bonded together by tie layers positioned between the plurality of layers.

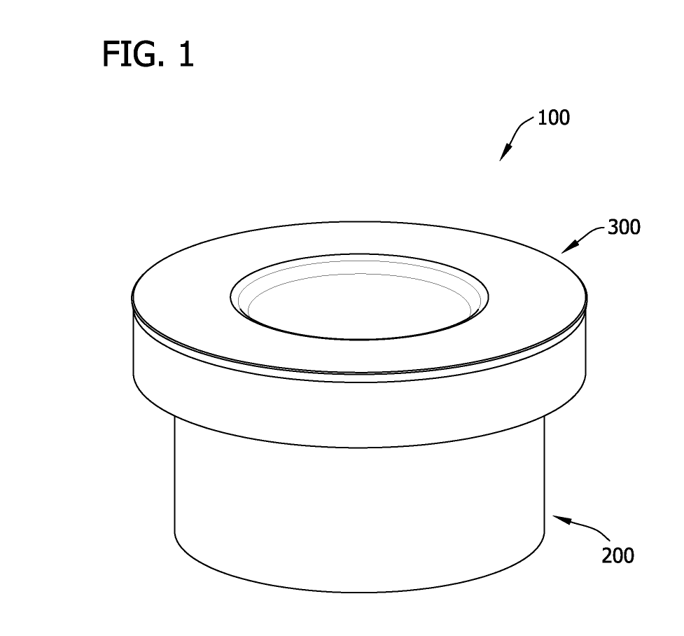

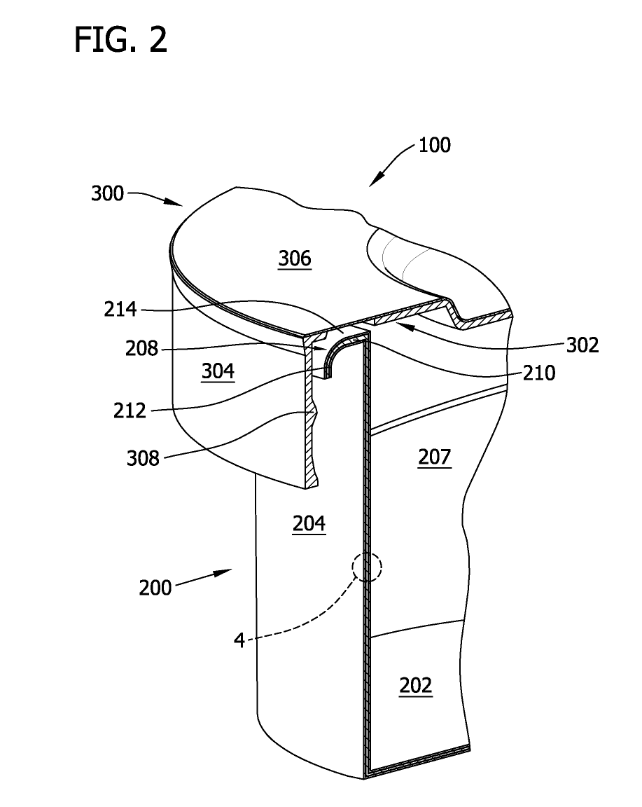

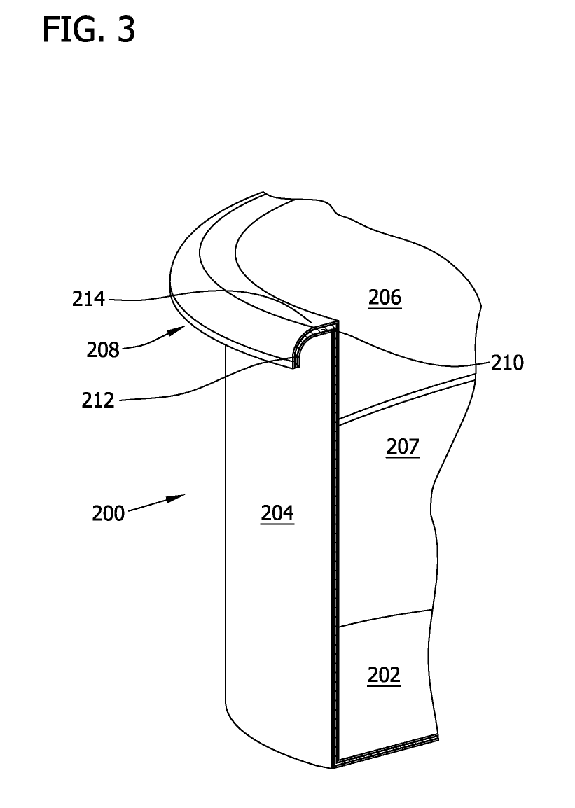

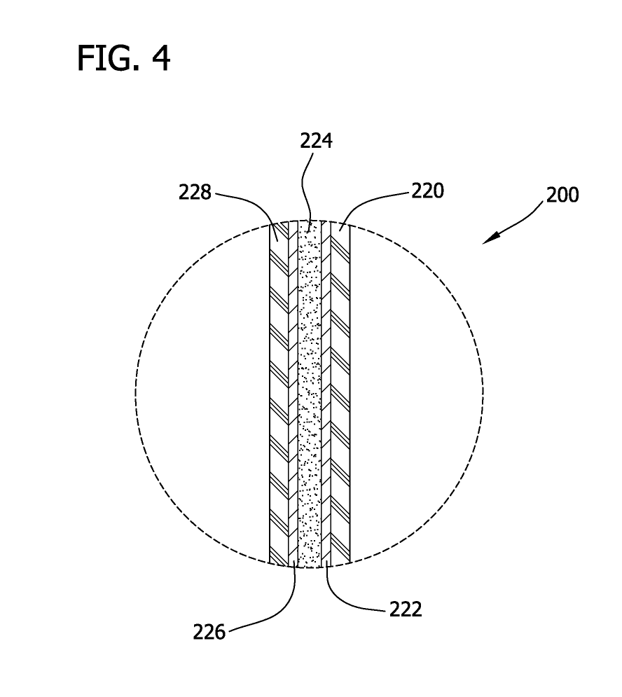

Referring to the drawings, FIG. 1 is a perspective view of an exemplary two-piece package 100, FIG. 2 is a cross-sectional view of two-piece package 100, FIG. 3 is a perspective view of container 200, and FIG. 4 is a blown-up cross-sectional view of container 200. Two-piece package 100 includes a container 200 and a lid 300. Container 200 is configured to receive perishable products and includes a bottom 202, a side wall 204, and an open end 206 opposite bottom 202. Bottom 202 and side wall 204 define an inner chamber 207 that may store perishable products. A circumferential flange 208 extends outward from open end 206 and circumscribes the periphery of open end 206. Circumferential flange 208 also includes an upper portion 210 and a side portion 212. Side portion 212 extends downward from an outer edge 214 of upper portion 210. Side portion 212 extends substantially perpendicular with respect to upper portion 210.

Container 200 may be formed from thermoplastic materials that have oxygen barrier and/or oxygen scavenging properties. In the exemplary embodiment, container 200 includes a plurality of thermoplastic layers, shown in FIG. 4. At least one layer includes thermoplastic materials having oxygen barrier and/or oxygen scavenging properties. For example, container 200 includes a first thermoplastic layer (cap layer) 220, a first adhesive layer (tie layer) 222, a barrier layer 224, a second adhesive layer (tie layer) 226, and a second thermoplastic layer (cap layer) 228. Adhesive layers 222 and 226 are positioned on either side of barrier layer 224 to bond first thermoplastic layer 222 to one side of barrier layer 224 and to bond second thermoplastic layer 228 to an opposite side of barrier layer 224. In other embodiments, container 200 may have additional thermoplastic layers. For example, container 200 may have two thermoplastic layers on each side of barrier layer 224. In one embodiment, adhesive layers 222 and 226 have a thickness of about 0.0005 inch to about 0.0015 inch, and in another embodiment, about 0.0008 inch to about 0.0012 inch. Barrier layer, in one embodiment, has a thickness of about 0.0005 inch to about 0.0030 inch, and in another embodiment, about 0.0008 inch to about 0.0020 inch. Cap layers 220 and 228 have a thickness, in one embodiment, of about 0.005 inch to about 0.050 inch, and in another embodiment, about 0.008 inch to about 0.030.

Barrier layer 224 may be formed by at least one of poly(ethylene vinyl alcohol) (EVOH), polyvinyl alcohol (PVOH), polyvinylidene chloride (PVDC), polyamide, acrylate copolymers, cyclic olefin copolymers, and the like. In another embodiment, barrier layer 224 may be a metal foil. Barrier layer 224 may also include fillers, for example, active/passive scavengers, nanofillers including talc, glass, clay, silica, mica, halloysite nanotubes, nanoclays, silicon dioxide, cellulose nanofibers, and the like. In addition, barrier layer 224 may be coated with a coating material that includes at least one oxide, for example, SiOₓ, AlOₓ, and other known oxides. Thermoplastic layers 220 and 228 may be formed from at least one of polypropylene, polyethylene, polybutylene, polystyrene, polyesters, and the like. Adhesive layers 222 and 226 may be formed from any suitable material, for example, but not limited to, a maleic anhydride grafted polypropylene adhesive material, a functionalized polyethylene material, and a functionalized polypropylene material. Examples of functionalized polypropylene may include a copolymer with polyproplylene, a polyamide, ethylene vinyl acetate, and blends of polyethylene and polypropylene.

Container 200 may be formed by thermoforming multi-layer thermoplastic sheet structures that include first thermoplastic layer 220, first adhesive layer (tie layer) 222, barrier layer 224, second adhesive layer (tie layer) 226, and second thermoplastic layer 228. The multi-layer sheets may be formed by at least one of a co-extrusion process, a lamination process, or a coating process.

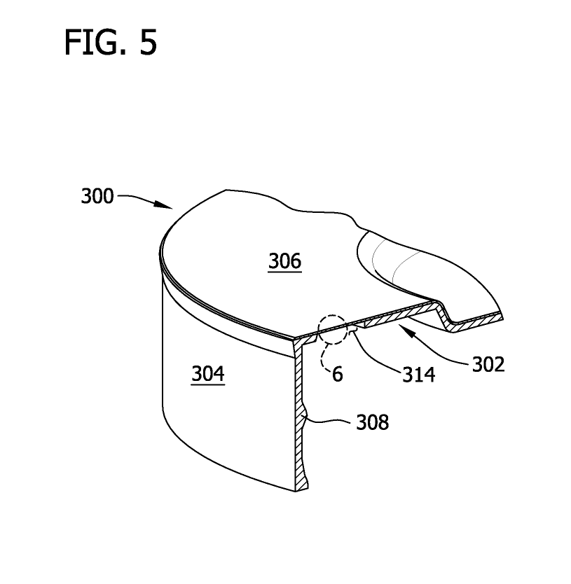

Referring to FIGS. 2 and 5, lid 300 is attachable to container 200 and includes a center portion 302, a rim portion 304, and a film 306 attached to each of center portion 302 and rim portion 304. Center portion 302 is positioned on an inner radial side of circumferential flange 208 and rim portion 304 is positioned on an opposite radial side of circumferential flange 208. Rim portion 304 includes a body extending substantially perpendicular with respect to center portion 302. In the exemplary embodiment, rim portion 304 includes a rib 308 adjacent to circumferential flange 208 that facilitates preventing separation of lid 300 from container 200. More specifically, side portion 212 of circumferential flange 208 is sandwiched between film 306 and rib 308 such that rib 308 must be disengaged from circumferential flange 208 to remove lid 300 from container 200. In the exemplary embodiment, rib 308 has a triangular cross-section. In other embodiments, rib 308 may be any suitable cross-section that prevents separation of lid 300 from container 200.

Film 306 seals to circumferential flange 208. Lid 300 includes a recess 314 formed between center portion 302, film 306, and rim portion 304. Recess 314 engages with circumferential flange 208 such that film 306 couples to an upper portion 210 of circumferential flange 208. Film 306 has oxygen barrier properties and is configured to cover open end 206 to facilitate preventing the ingress of oxygen into container 200. For example, film 306 is coupled to the outer surface of center portion 302 and extends past circumferential flange 208 to rim portion 304. As such, film 306 facilitates preventing the ingress of oxygen into container 200 before oxygen reaches center portion 302. Center portion 302 and rim portion 304 may include one or more thermoplastic layers. In one embodiment, one of the thermoplastic layers is formed from thermoplastic materials having oxygen barrier and/or oxygen scavenging properties.

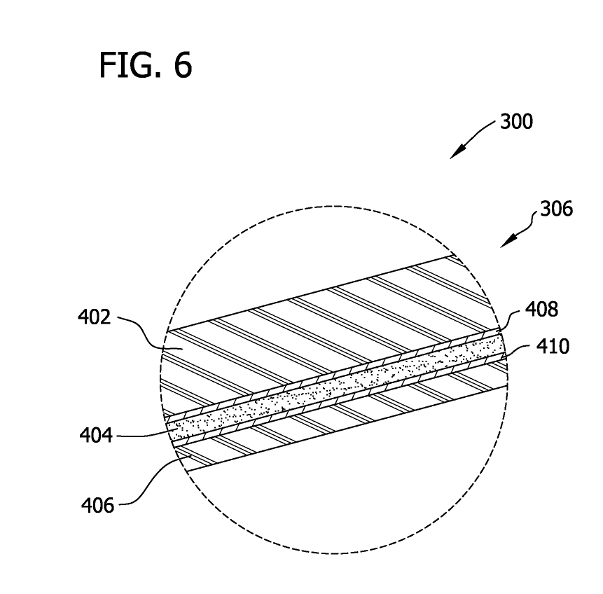

FIG. 6 is a blown-up cross-sectional view of lid 300. In the exemplary embodiment, film 306 includes a plurality of thermoplastic layers, with at least one layer including thermoplastic materials having oxygen barrier and/or oxygen scavenging properties. Specifically, lid 300 includes a printable layer 402, a sealing layer 406, a barrier layer 404 that has oxygen barrier properties, and tie layers 408 and 410. Barrier layer 404 is positioned between printable layer 402 and sealing layer 406. Tie layers 408 and 410 are positioned on either side of barrier layer 404 to bond printable layer 402 to one side of barrier layer 404, and to bond sealing layer 406 to an opposite side of barrier layer 404. In an alternative embodiment, film 306 may be a mono-layer substrate having oxygen barrier properties. In other embodiments, lid 300 may have additional thermoplastic layers. For example, lid 300 may have two thermoplastic layers on each side of barrier layer 404.

Tie layers 408 and 410 are formed of an adhesive material. Tie layers 408 and 410 may be formed of any suitable material, for example, but not limited to, a maleic anhydride grafted polypropylene adhesive material, a functionalized polyethylene material (for example, maleic anhydride grafted polyethylene, and ethylene-acrylate copolymer), and a functionalized polypropylene material. Examples of functionalized polypropylene may include a copolymer with polypropylene, a polyamide, and blends of polyethylene and polypropylene. Printable layer 402 and sealing layer 406 may be formed from at least one of polypropylene, polyethylene, polybutylene, polyesters, and the like.

In the exemplary embodiment, barrier layer 404 has oxygen barrier properties such that barrier layer 404 facilitates preventing the ingress of oxygen into container 200 through lid 300. Barrier layer 404 may be formed of any suitable material for example, but not limited to, ethylene vinyl alcohol (EVOH), polyvinylidene chloride, polyethylene terephthalate, calcium carbonate filled polypropylene, talc filled polypropylene, nanoclays, silicon dioxide, an oxygen scavenging material, and a metalized material. In addition, barrier layer 404 may be coated with a coating material that includes at least one oxide, for example, SiOₓ, AlOₓ, and other known oxides. In another embodiment, barrier layer 404 may be a metal foil. Barrier layer 404 has a thickness, in one embodiment, of about 5 μm to about 50 μm, and in another embodiment, about 10 μm to about 40 μm. Sealing layer 406 has a thickness, in one example, of about 10 μm to about 50 μm, and in another embodiment, of about 20 μm to about 40 μm. In addition, printable layer 402 has a thickness, in one embodiment, of about 10 μm to about 100 μm, and in another embodiment, of about 20 μm to about 80 μm.

Moreover, film 306 has an oxygen transmission rate of about 0.005 cc/100 in²/24 hr to about 6.0 cc/100 in²/24 hr. In another embodiment, film 306 has an oxygen transmission rate of about 0.01 cc/100 in²/24 hr to about 3.0 cc/100 in²/24 hr.

A method of assembling two-piece package 100 is also described herein. The method includes forming a container 200, forming a lid 300, and attaching lid 300 to container 200. Furthermore film 306 is injection molded to center portion 302 and rim portion 304 to form lid 300. During injection molding, film 306 is subjected to an in-mold labeling process, wherein a package label is integrated into lid 300. In the exemplary embodiment, at least one of the layers of film 306 is printing layer 402. During injection molding, printing layer 402 is the outermost layer of film 306 such that printing layer 402 is configured to receive the in-mold label. To seal lid 300 to container to container, a portion of sealing layer 406 is left exposed on the underside of lid 300 between center portion 302 and rim portion 304. Lid 300 is positioned on container 200 so that exposed sealing layer 406 is positioned on flange 208 of container 200. Lid 300 is then sealed to container 200 by welding the two components together with pressure of about 0.5 kN to about 2.0 kN, a heating temperature of about 130° C. to about 250° C., and time of about 0.3 second to about 2 seconds.

Assembling two-piece package 100 may also include a retort sterilization process. Heating container 200 and lid 300 of assembled package 100 facilitates sterilization of the package contents and improves the shelf life of the package contents. Specifically, container 200 is filled with product, lid 300 is sealed to flange 208 as explained above, and then placed in retort chamber for cooking/sterilization.

Two-piece package 100 described herein facilitates preventing the ingress of oxygen into package 100 improving the shelf life of package contents. More specifically, in-mold labeled lid 300 of two-piece package 100 described herein facilitates retarding spoliation of perishable products within container 200.

Although specific features of various embodiments may be shown in some drawings and not in others, this is for convenience only. Any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of assembling a two-piece package, said method comprising:
forming a container comprising a side wall, a bottom, an open end, and a circumferential flange extending outward from the open end, each of the bottom, the side wall, and the circumferential flange comprise a material having oxygen barrier properties;
forming a lid comprising:
a center portion;
a rim portion comprising a body extending substantially perpendicular with respect to the center portion; and
a film attached to each of the center portion and the rim portion, the film comprising a plurality of layers, at least one of the plurality of layers comprising a material having oxygen barrier properties; and
attaching the lid to the container such that the film is coupled to the circumferential flange to seal the two-piece package.

2. The method in accordance with claim 1, wherein said attaching the lid further comprises sealing the film to the circumferential flange.

3. The method in accordance with claim 2, wherein said sealing the film comprises bonding the film to the circumferential flange by heat and pressure.

4. The method in accordance with claim 1, wherein said forming a lid further comprises forming the film with a printable layer, a sealing layer, and a barrier layer having oxygen barrier properties.

5. The method in accordance with claim 4, wherein said forming the film comprises positioning the barrier layer between the printable layer and the sealing layer.

6. The method in accordance with claim 4, wherein said forming the film comprises forming the barrier layer with at least one of ethylene vinyl alcohol, polyvinylidene chloride, polyethylene terephthalate, calcium carbonate filled polypropylene, talc filled polypropylene, nanoclays, silicon dioxide, an oxygen scavenging material, a metalized material, a metal foil, and a coating composition comprising an oxide.

7. The method in accordance with claim 4, wherein said forming the film further comprises in-mold labeling the printable layer.

8. The method in accordance with claim 4, wherein said forming the film further comprises forming the film such that the film has an oxygen transmission rate of about 0.005 cc/100 in²/24 hr to about 6.0 cc/100 in²/24 hr.

9. The method in accordance with claim 1, wherein said attaching the lid further comprises positioning the center portion and the rim portion on opposing radial sides of the circumferential flange.

10. The method in accordance with claim 1, wherein said forming a container further comprises forming the container from a container material that comprises a plurality of layers, at least one of the plurality of layers comprising oxygen barrier properties.

11. The method in accordance with claim 1, wherein said forming a lid comprises bonding the film to the center portion and the rim portion.

12. The method in accordance with claim 1, wherein said method further comprises placing a product into the container, sealing the lid to the container, and retorting the container and the lid such that said retorting facilitates sterilizing the product within the two-piece package.

13. A two-piece package comprising:
a container comprising a side wall, a bottom, an open end, and a circumferential flange extending outward from said open end, each of said bottom, said side wall, and said circumferential flange comprise a material having oxygen barrier properties; and
a lid attachable to said container, said lid comprising:
a center portion;
a rim portion comprising a body extending substantially perpendicular with respect to said center portion; and
a film attached to each of said center portion and said rim portion, said film comprising a plurality of layers, at least one of said plurality of layers comprising a material having oxygen barrier properties, said film configured to seal to said circumferential flange.

14. The package in accordance with claim 13, wherein said plurality of layers comprises a printable layer, a sealing layer and a barrier layer having oxygen barrier properties.

15. The package in accordance with claim 14, wherein said printable layer is configured to receive an in-mold label.

16. The package in accordance with claim 14, wherein said printable layer comprises at least one of polypropylene, polyethylene, polybutylene, and polyester.

17. The package in accordance with claim 14, wherein said barrier layer is positioned between said printable layer and said sealing layer.

18. The package in accordance with claim 14, wherein said barrier layer comprises at least one of ethylene vinyl alcohol, polyvinylidene chloride, polyethylene terephthalate, calcium carbonate filled polypropylene, talc filled polypropylene, nanoclays, silicon dioxide, an oxygen scavenging material, a metalized material, a metal foil, and a coating composition comprising an oxide.

19. The package in accordance with claim 13, wherein said film comprises a first tie layer positioned between said barrier layer and said printable layer, and a second tie layer positioned between said sealing layer and said barrier layer.

20. The package in accordance with claim 19, wherein said first and second tie layers comprise at least one of a maleic anhydride grafted polypropylene adhesive material, a functionalized polyethylene material, and a functionalized polypropylene material.

21. The package in accordance with claim 13, wherein said film comprises an oxygen transmission rate of about 0.005 cc/100 in²/24 hr to about 6.0 cc/100 in²/24 hr.

22. The package in accordance with claim 21, wherein said film comprises an oxygen transmission rate of about 0.01 cc/100 in²/24 hr to about 3.0 cc/100 in²/24 hr.

23. The package in accordance with claim 13, wherein said container comprises a plurality of layers, at least one of said plurality of layers comprising a material having at least one of oxygen barrier properties and oxygen scavenging properties.

24. The package in accordance with claim 23, wherein at least one layer of said plurality of layers of said container comprises a material comprising polypropylene, polyethylene, and polyester.

25. The package in accordance with claim 13, wherein said film is coupled to an outer surface of said center portion and extends past said circumferential flange to said rim portion.

26. An in-mold labeled lid for use with a container comprising:
a center portion;
a rim portion comprising a body extending substantially perpendicular with respect to said center portion; and
a film attached to each of said center portion and said rim portion, said film comprising a plurality of layers, at least one of said plurality of layers comprising a material having oxygen barrier properties.

27. The lid in accordance with claim 26, wherein said plurality of layers comprises a printable layer, a sealing layer, and a barrier layer having oxygen barrier properties.

28. The lid in accordance with claim 27 wherein said barrier layer is positioned between said printable layer and said sealing layer.

29. The lid in accordance with claim 27, wherein said film comprises a first tie layer positioned between said barrier layer and said printable layer, and a second tie layer positioned between said sealing layer and said barrier layer.

30. The lid in accordance with claim 29, wherein said first and second tie layers comprise at least one of a maleic anhydride grafted polypropylene adhesive, a functionalized polyethylene, and a functionalized polypropylene.

31. The lid in accordance with claim 27, wherein said barrier layer is one of ethylene vinyl alcohol, polyvinylidene chloride, polyethylene terephthalate, calcium carbonate filled polypropylene, talc filled polypropylene, nanoclays, silicon dioxide, an oxygen scavenging material, a metalized material, a metal foil, and a coating composition comprising an oxide.

32. The lid in accordance with claim 26, wherein said film comprises an oxygen transmission rate of about 0.005 cc/100 in²/24 hr to about 6.0 cc/100 in²/24 hr.

33. The lid in accordance with claim 32, wherein said film comprises an oxygen transmission rate of about 0.01 cc/100 in²/24 hr to about 3.0 cc/100 in²/24 hr.
